(19) United States
(12) Patent Application Publication
(10) Pub. No.: US 2025/0239920 A1
(43) Pub. Date: Jul. 24, 2025

(54) ELECTRIC POWER UNIT AND WORKING MACHINE

(71) Applicant: HONDA MOTOR CO., LTD., Tokyo (JP)

(72) Inventors: Naoki MATSUNAGA, Saitama (JP); Hiroshi Mizuguchi, Saitama (JP); Naohiro AKiyama, Saitama (JP)

(73) Assignee: HONDA MOTOR CO., LTD., Tokyo (JP)

(21) Appl. No.: 19/172,681

(22) Filed: Apr. 8, 2025

Related U.S. Application Data
(63) Continuation of application No. 17/789,027, filed on Jun. 24, 2022, now abandoned.

(51) Int. Cl. H02K 11/30; B60K 1/04; H02K 5/04

(52) U.S. Cl. CPC H02K 11/30; B60K 1/04; H02K 5/04

(57) ABSTRACT

An electric power unit includes an electric motor, a battery for driving the electric motor, and a battery tray for supporting the battery. The battery tray is attached to the electric motor via elastic members. The electric power unit is provided with oscillating direction restricting portions, a front side convex portion, and a rear side convex portion for restricting relative movement of the battery tray and the electric motor in at least one direction of an attachment direction of the elastic members and an oscillating direction substantially perpendicular to the attachment direction.

### CROSS REFERENCE TO PRIOR APPLICATION

This application is a continuation of U.S. patent application Ser. No. 17/789,027 (filed on Jun. 24, 2022), which is a National Stage Patent Application of PCT International Patent Application No. PCT/JP2019/051343 (filed on Dec. 26, 2019) under 35 U.S.C. § 371,which are all hereby incorporated by reference in their entirety.

### TECHNICAL FIELD

The present invention relates to an electric power unit mounted on a construction machine, a working machine, or the like, and relates to a working machine on which the electric power unit is mounted.

### BACKGROUND ART

Based on related art, there has been known construction machines and working machines using an engine (internal combustion engine) as a drive source. For example, Patent Literature 1 discloses a plate compactor (leveling machine) using an engine as the drive source.

In recent years, with an increasing awareness of global environmental protection, in vehicles, drive sources of hybrid vehicles, electric vehicles, and the like have been rapidly electrified. In a construction machine, a working machine, or the like including the plate compactor (leveling machine), it is desired to electrify the drive source.

On the other hand, when an attempt is made to electrify the drive source of the working machine, it is necessary to design an electric motor and an attachment portion of an electronic component exclusively for each shape of the working machine in order to attach the electronic component such as the electric motor as the drive source, a battery for driving the electric motor, and a power drive unit (PDU) to the working machine. Therefore, when the drive source of the working machine is to be electrified, there is a problem that a manufacturing cost increases.

Therefore, in order to prevent the increase in manufacturing cost, it has been considered to attach the electronic component to the electric motor and attach an electric power unit in which the electric motor and the electric component are integrated to the working machine.

### CITATION LIST

### Patent Literature

Patent Literature 1: JP-UM-A-H07-042367

### SUMMARY OF INVENTION

### Technical Problem

However, when the electric power unit in which the electric motor and the electronic component are integrated is attached to the working machine, in the electronic component, both vibration caused by driving of the electric motor and vibration caused by driving of the working machine are transmitted to the electronic component. In addition, when the vibration caused by the driving of the electric motor and the vibration caused by the driving of the working machine resonate with each other, the vibration becomes large and is transmitted to the electronic component. Therefore, there is a possibility of an occurrence of a failure in the electronic component due to the vibration.

The present invention provides an electric power unit to prevent vibration of an electronic component.

### Solution to Problem

The present invention relates to an electric power unit, the electric power unit includes:
a rotary electric machine;
an electronic component configured to drive the rotary electric machine; and
an electronic component support member which supports the electronic component, in which:
the electronic component support member is attached to the rotary electric machine via an elastic member; and
a restricting portion which restricts relative movement of the electronic component support member and the rotary electric machine in at least one direction of an attachment direction of the elastic member and an oscillating direction substantially perpendicular to the attachment direction is provided.

### Advantageous Effects of Invention

According to the present invention, when vibration equal to or greater than a predetermined value occurs in at least one direction of the attachment direction and the oscillating direction of the elastic member with respect to an elastic force of the elastic member, the vibration can be restricted by the restricting portion. Accordingly, the electronic component can be prevented from oscillating at a large amplitude equal to or greater than a predetermined value in at least one direction of the attachment direction and the oscillating direction of the elastic member, and thus the vibration of the electronic component can be prevented.

### BRIEF DESCRIPTION OF DRAWINGS

FIG. 1 is a perspective view of a leveling machine on which an electric power unit according to an embodiment of the present invention is mounted.

FIG. 2 is a perspective view of the electric power unit according to the embodiment of the present invention.

FIG. 3 is an exploded perspective view of the electric power unit in FIG. 2.

FIG. 4 is a cross-sectional view of a main part of the electric power unit in FIG. 2.

FIG. 5A is a perspective view of a tray support plate of the electric power unit in FIG. 2, as viewed obliquely from an up side.

FIG. 5B is a perspective view of the tray support plate of the electric power unit in FIG. 2, as viewed obliquely from a down side.

FIG. 6 is a cross-sectional view of a main part of a left end portion of the electric power unit in FIG. 2.

FIG. 7 is a cross-sectional view of a main part of a center portion of the electric power unit in FIG. 2 in a left-right direction.

FIG. 8 is a perspective view for illustrating attachment of a PDU of the electric power unit in FIG. 2 to a rotary electric machine.

FIG. 9 is a perspective view of an upper side attachment member and a lower side attachment member of the PDU of the electric power unit in FIG. 2.

FIG. 10 is a cross-sectional view of a main part around an oscillating direction restricting portion (upper side) in FIG. 9.

FIG. 11 is a cross-sectional view of the main part around the oscillating direction restricting portion (lower side) in FIG. 9.

FIG. 12 is a cross-sectional view of a main part of a right end portion of the electric power unit in FIG. 2.

### DESCRIPTION OF EMBODIMENTS

Hereinafter, an embodiment of an electric power unit of the present invention will be described with reference to the accompanying drawings.

The electric power unit according to the present invention can be widely mounted on various machines and devices, and in the present invention, specific machines and devices on which the electric power unit is mounted are not limited at all, but for example, the electric power unit is mounted on a working machine. Examples of the working machine include a leveling machine, a lawn mower, a cultivator, and a snow blower.

In the present embodiment, an electric power unit 1 is mounted on a leveling machine 100. In the following description, front and rear, left and right, and up and down are described in accordance with directions viewed from an operator of the leveling machine 100. In the drawings, a front side is denoted by Fr, a rear side is denoted by Rr, a left side is denoted by L, a right side is denoted by R, an up side is denoted by U, and a down side is denoted by D.

### Leveling Machine

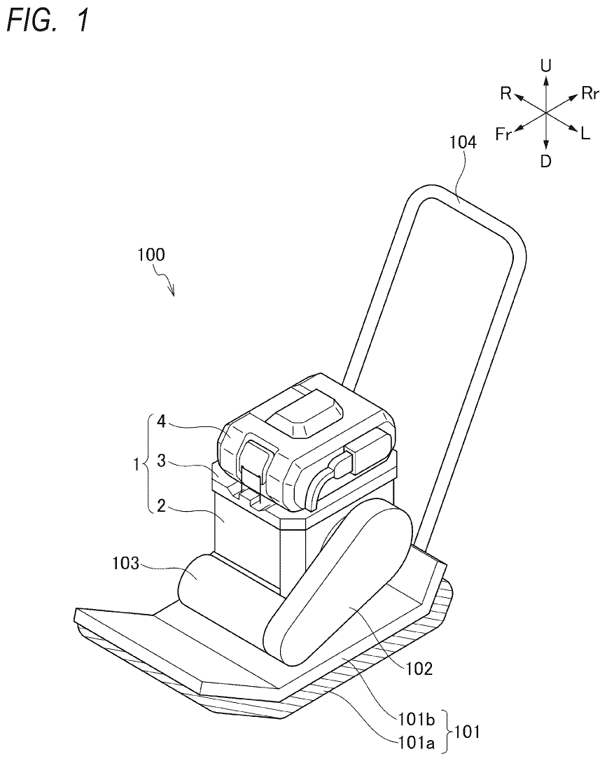

As illustrated in FIG. 1, the leveling machine 100 includes the electric power unit 1, a working mechanism portion 101, a power transmission mechanism portion 102, a vibration mechanism portion 103, and a handle 104.

The electric power unit 1 includes a power unit main body 2, a battery tray 3 provided on an upper portion of the power unit main body 2, and a battery 4 placed on the battery tray 3 and serving as an energy source for driving the power unit main body 2. Details of a configuration of the electric power unit 1 will be described later.

The working mechanism portion 101 is a part which mainly performs rolling compaction on the ground. The working mechanism portion 101 includes a rolling compaction plate 101a which comes into contact with the ground, and a base 101b disposed on an upper surface of the rolling compaction plate 101a. The electric power unit 1 is attached to an upper surface of the base 101b.

The power transmission mechanism portion 102 transmits rotational power of a motor included in the power unit main body 2 to the vibration mechanism portion 103 via a power transmission member (not illustrated) such as a belt or a chain.

The vibration mechanism portion 103 has an eccentric load (not illustrated) which is connected to the power transmission mechanism portion 102 such that power transmission can be performed. The vibration mechanism portion 103 rotates the eccentric load by the rotational power from the electric power unit 1 transmitted by the power transmission mechanism portion 102, thereby vibrating the rolling compaction plate 101a of the working mechanism portion 101 5 up and down to generate a compaction force with respect to the ground.

The handle 104 is formed in a bar shape which can be gripped by an operator in a standing state. As a result, the operator can perform rolling compaction work on the ground while gripping the handle 104 and moving the leveling machine 100.

### Electric Power Unit

### (Overall Configuration)

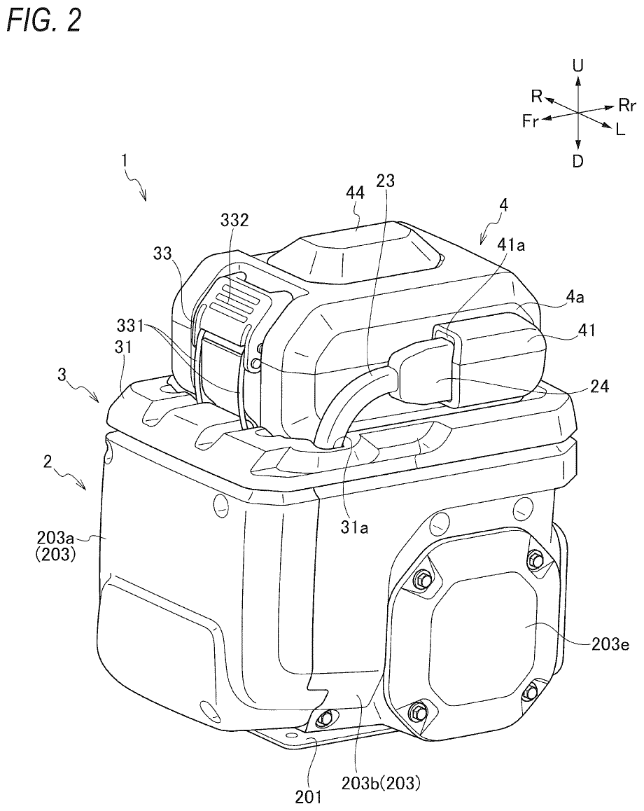

As illustrated in FIGS. 2 to 4, the electric power unit 1 includes the power unit main body 2, the battery tray 3 provided on the upper portion of the power unit main body 2, and the battery 4 placed on the battery tray 3 and serving as the energy source for driving the power unit main body 2.

### (Power Unit Main Body)

The power unit main body 2 includes an electric motor 20 and a power drive unit (PDU) 21.

The electric motor 20 is a drive source of the leveling machine 100 which generates the rotational power for driving the vibration mechanism portion 103 via the power transmission mechanism portion 102. The electric motor 20 is attached to a base plate 201 such that a rotation axis 20a extends in the left-right direction.

The base plate 201 for attaching the electric motor 20 to the base 101b of the working mechanism portion 101 and a support frame plate 202 for attaching the PDU 21 and the battery tray 3 to the electric motor 20 are attached to the electric motor 20. The base plate 201 extends over a lower surface of the electric motor 20. The support frame plate 202 has a battery tray attachment surface 202a extending over an upper surface of the electric motor 20, and a PDU attachment surface 202b extending over a front surface of the electric motor 20.

The PDU 21 is a device for controlling distribution of electric power from the battery 4 to the electric motor 20 and other electric components in the power unit main body 2. The PDU 21 is disposed on a front side of the electric motor 20. The PDU 21 includes a plurality of connection portions, and a first connection portion 21a of the plurality of connection portions is connected to an input harness 23 for introducing electric power from the battery 4 into the PDU 21 by electrically connecting to the battery 4. A connection terminal 24 connected to the battery 4 is provided at a distal end of the input harness 23. An output harness 25 for supplying the electric power introduced via the connection terminal 24 and the input harness 23 to the electric motor 20 is connected to a second connection portion 21b of the plurality of connection portions of the PDU 21. A sensor harness 26 for electrical connection with other electric components such as a sensor is connected to a third connection portion 21c of the plurality of connection portions of the PDU 21.

Outer peripheries of the electric motor 20 and the PDU 21 are covered by an electric motor cover 203. The electric motor cover 203 includes a first electric motor cover 203a, a second electric motor cover 203b, and a third electric motor cover 203c. That is, the first electric motor cover 203a, the second electric motor cover 203b, and the third electric motor cover 203c constitute a housing which covers front and rear side surfaces and left and right side surfaces of the power unit main body 2. In the present embodiment, the first electric motor cover 203a covers the front side surface, a part of the right side surface, and a part of the left side surface of the power unit main body 2, the second electric motor cover 203b covers the left side surface and the rear surface, on the left side, of the power unit main body 2, and the third electric motor cover 203c covers the right side surface and the rear surface, on the right side, of the power unit main body 2. The second electric motor cover 203b includes a gas intake port 203d opened for a cooling fan (not illustrated) disposed on a left side of the electric motor 20. The gas intake port 203d is covered by a fan cover 203e.

### (Battery Tray)

The battery tray 3 is a member for attaching to the power unit main body 2 to place the battery 4. The battery tray 3 according to the present embodiment includes a rectangular tray main body 30 which is attached to the battery tray attachment surface 202a of the support frame plate 202, and a rectangular frame-shaped decorative cover 31 which is attached to the tray main body 30 so as to surround an outer periphery of the tray main body 30.

A holding claw portion 32 which protrudes toward to the up side and locks the battery 4 is provided at a rear end of the tray main body 30. A buckle 33 which engages with the battery 4 is provided at a front end of the tray main body 30. The buckle 33 includes a movable portion 331 provided to be capable of rotating with respect to the tray main body 30, and a lever portion 332 provided to be capable of continuously rotating with respect to a distal end of the movable portion 331.

Guide support portions 36 which extend in a front-rear direction and protrude toward the up side are provided at a left end and a right end of the tray main body 30. When the battery 4 is placed on the battery tray 3, the battery 4 is guided to an appropriate position on the tray main body 30 by the guide support portions 36.

On an upper surface of the tray main body 30, for example, a plurality of placement members 37 made of an elastic body such as rubber or resin are provided. In the present embodiment, the placement members 37 are provided at four positions on a left front side, a right front side, a left rear side, and a right rear side of the upper surface of the tray main body 30. Upper surfaces of the placement members 37 each has a concave-convex shape. When the battery 4 is placed on the battery tray 3, the placement members 37 receive a weight of the battery 4 and are elastically deformed, so as to elastically support the battery 4.

A tray support plate 38 having a substantially rectangular flat plate shape and extending substantially horizontally is provided on a lower surface of the tray main body 30.

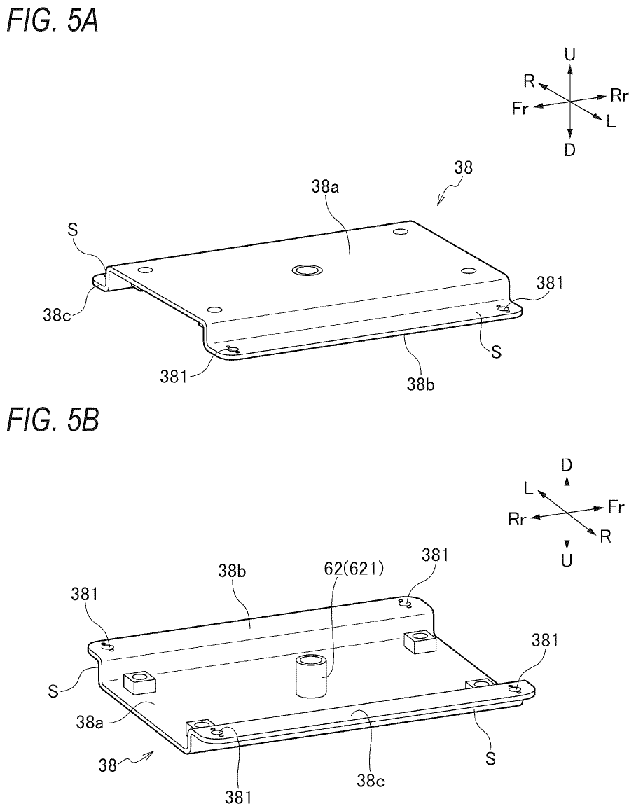

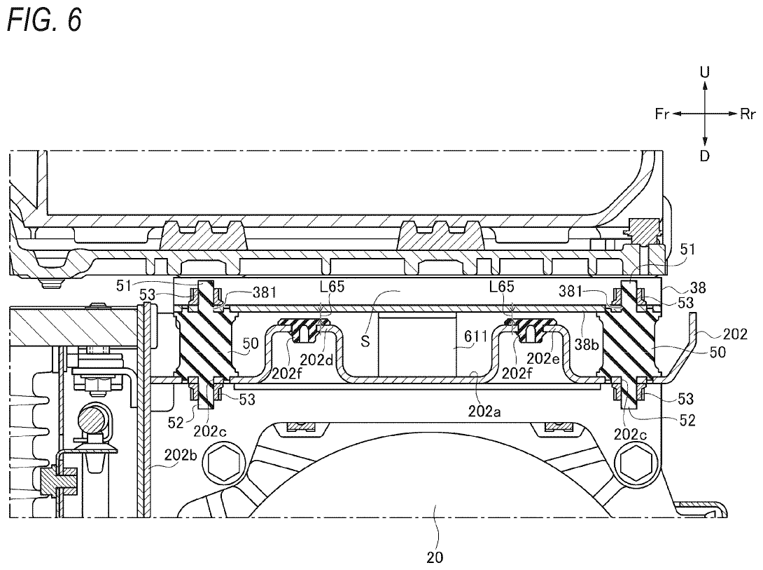

As illustrated in FIGS. 5A, 5B, and 6, the tray support plate 38 includes a main surface 38a which abuts on the lower surface of the tray main body 30 and extends substantially horizontally, a left end portion 38b which is curved toward the down side from a left end of the main surface 38a and forms a substantially horizontal surface extending in the front-rear direction below the main surface 38a, and a right end portion 38c which is curved toward the down side from a right end of the main surface 38a and forms a substantially horizontal surface extending in the front-rear direction below the main surface 38a. As a result, the tray support plate 38 is formed as a concave-convex surface, and thus rigidity is improved.

A predetermined gap S is formed in an up-down direction between the left end portion 38b and the right end portion 38c of the tray support plate 38 and the lower surface of the tray main body 30. The tray support plate 38 is attached to the battery tray attachment surface 202a of the support frame plate 202 via elastic members 50 each made of an elastic body such as rubber or resin. In this manner, the battery tray 3 is attached to the electric motor 20 via the elastic members 50.

An input harness draw-out portion 31a which is formed so as to be partially recessed toward an outer peripheral side and through which the input harness 23 is inserted is provided on a left side of an inner periphery of the decorative cover 31. The input harness draw-out portion 31a is disposed at a position which is close to the front side in a front view and corresponds to the PDU 21. The input harness 23 and the connection terminal 24 accommodated inside the first electric motor cover 203a and the second electric motor cover 203b are drawn out from the input harness draw-out portion 31a to an up side of the battery tray 3.

### (Battery)

Returning to FIGS. 2 to 4, the battery 4 has a substantially rectangular parallelepiped shape, and is provided so as to be capable of detaching from the battery tray 3 at an upper portion of the power unit main body 2.

The battery 4 is provided with a connection portion 41 for connecting the connection terminal 24 of the input harness 23 and a connector portion (not illustrated) in the battery 4. The connection portion 41 is provided on a left side surface 4a of the battery 4 so as to protrude toward the left side. The connection portion 41 has an opening portion 41a which is open to a front direction. The connection terminal 24 of the input harness 23 is inserted into the opening portion 41a in a state where the battery 4 is attached to the battery tray 3. In this manner, the battery 4 and the PDU 21 are electrically connected to each other.

A plurality of substantially cylindrical battery cells 400 extending in the left-right direction are accommodated in the battery 4 in the front-rear direction and the up-down direction. A locking groove portion 42 is provided in a lower portion of a rear surface 4b of the battery 4. An engaged portion 43 to be engaged with the buckle 33 on the tray main body 30 is provided from a front surface 4c to an upper surface 4d of the battery 4. A handle portion 44 used when the battery 4 is carried is provided on the upper surface 4d of the battery 4.

A distal end of the holding claw portion 32 of the tray main body 30 is locked to the locking groove portion 42. Therefore, a rear end of the battery 4 is fixed to the holding claw portion 32 of the tray main body 30. The lever portion 332 of the buckle 33 is engaged with the engaged portion 43. Therefore, a front end of the battery 4 is fixed to the tray main body 30 by the buckle 33. In this manner, the battery 4 is fixed to the tray main body 30.

### (Attachment of Battery Tray)

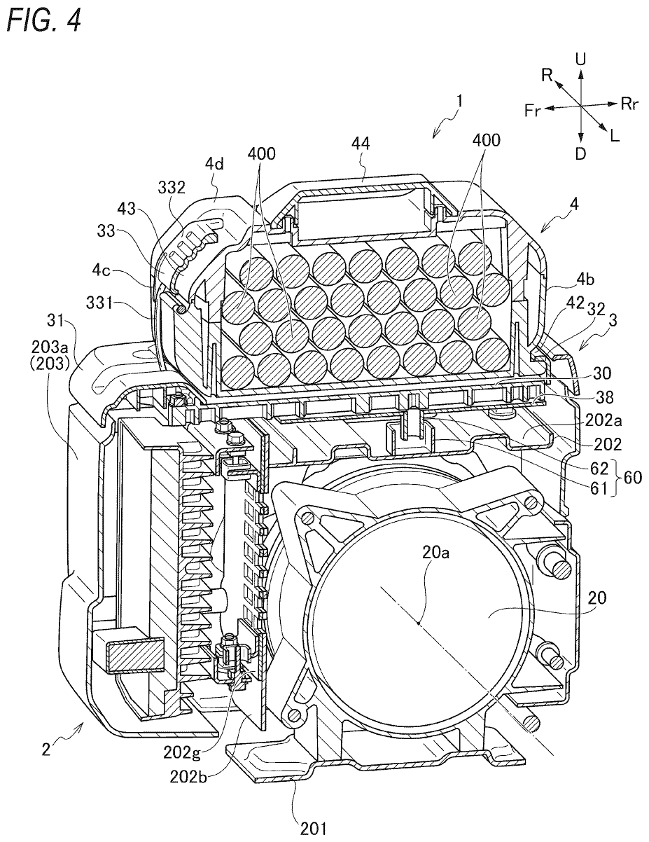

Attachment of the battery tray 3 to the battery tray attachment surface 202a will be described with reference to FIGS. 4 to 7.

The flat plate-shaped tray support plate 38 provided on the lower surface of the tray main body 30 and the battery tray attachment surface 202a of the support frame plate 202 of the electric motor 20 face each other in the up-down direction. A plurality of elastic members 50 are disposed between the flat plate-shaped tray support plate 38 provided on the lower surface of the tray main body 30 and the battery tray attachment surface 202a of the support frame plate 202 of the electric motor 20. In the present embodiment, the elastic members 50 are disposed at four positions in total on a front side and a rear side of the left end portion 38b of the tray support plate 38 and a front side and a rear side of the right end portion 38c of the tray support plate 38.

Through holes 381 penetrating the left end portion 38b and the right end portion 38c of the tray support plate 38 in the up-down direction are provided at positions where the elastic members 50 are disposed (see FIGS. 5A and 5B). Similarly, through holes 202c penetrating the battery tray attachment surface 202a in the up-down direction are provided at the positions where the elastic members 50 are disposed.

The elastic member 50 has a substantially cylindrical shape extending in the up-down direction, and an upper end and a lower end thereof each has a large diameter so as to have a flange shape. The elastic member 50 is provided with an upper surface protruding portion 51 protruding toward the up side from an upper surface and a lower surface protruding portion 52 protruding toward the down side from a lower surface. Each of the upper surface protruding portion 51 and the lower surface protruding portion 52 has a cylindrical shape having a diameter smaller than that of the upper surface and the lower surface of the elastic member 50, and a screw groove is formed on an outer peripheral surface thereof.

In each elastic member 50, the upper surface protruding portion 51 is inserted through the through hole 381 of the tray support plate 38 and protrudes toward the up side from the tray support plate 38, and the lower surface protruding portion 52 is inserted through the through hole 202c of the battery tray attachment surface 202a and protrudes toward the down side from the battery tray attachment surface 202a. Fastening nuts 53 are fastened to the upper surface protruding portion 51 protruding toward the up side from the tray support plate 38 and the lower surface protruding portion 52 protruding toward the down side from the battery tray attachment surface 202a. In this manner, the battery tray 3 is attached to the electric motor 20 via the elastic members 50. At this time, the elastic members 50 are attached to the tray support plate 38 and the battery tray attachment surface 202a in the up-down direction.

As described above, the battery tray 3 is attached to the electric motor 20 via the elastic members 50 attached in the up-down direction. Therefore, the battery tray 3 can oscillate with respect to the electric motor 20 in a substantially horizontal direction substantially perpendicular to the up-down direction, which is an attachment direction of the elastic members 50, by an elastic force of the elastic members 50. Further, the battery tray 3 can be relatively moved to the electric motor 20 also in the up-down direction, which is the attachment direction of the elastic members 50, by the elastic force of the elastic members 50. As a result, vibration generated by the vibration mechanism portion 103, the electric motor 20, and the like is absorbed by the elastic members 50, and thus it is possible to reduce transmission of the vibration generated by the vibration mechanism portion 103 and the electric motor 20 to the battery tray 3.

Further, the battery tray 3 and the support frame plate 202 of the electric motor 20 is provided with an oscillating direction restricting portion 60 which restricts relative movement of the battery tray 3 to the electric motor 20 in an oscillating direction substantially perpendicular to the attachment direction of the elastic members 50, that is, in a substantially horizontal direction substantially perpendicular to the up-down direction which is the attachment direction of the elastic members 50.

The oscillating direction restricting portion 60 includes an electric motor side restricting portion 61 provided on the battery tray attachment surface 202a of the support frame plate 202 of the electric motor 20, and a battery tray side restricting portion 62 provided on the tray support plate 38 of the battery tray 3.

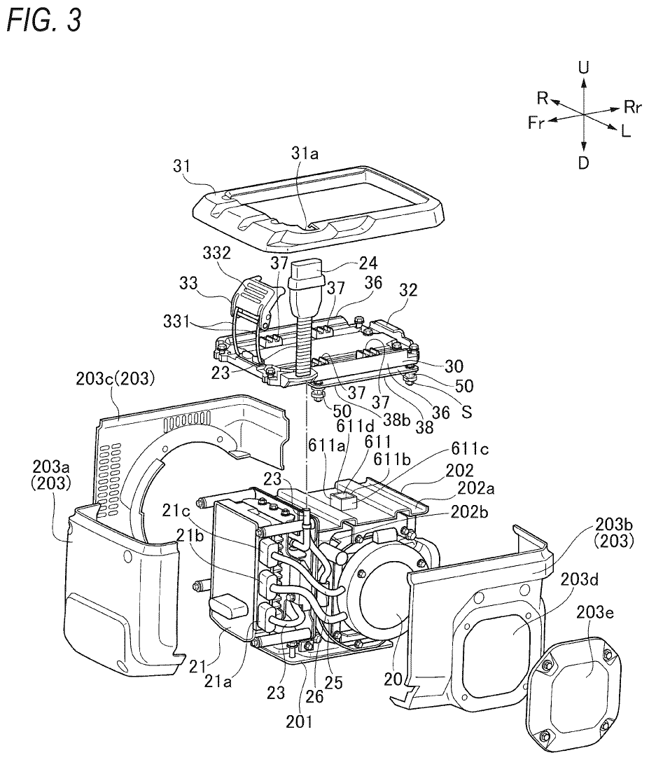

The electric motor side restricting portion 61 includes a tubular portion 611 which extends in the up-down direction and is formed at a substantially center portion of the battery tray attachment surface 202a in the front-rear direction and the left-right direction. The tubular portion 611 has a rectangular tubular shape, and includes a front surface 611a and a rear surface 611b extending in the left-right direction, and a left side surface 611c and a right side surface 611d extending in the front-rear direction (see FIG. 3). On an inner peripheral surface of the tubular portion 611, for example, an elastic member 612 made of an elastic body such as rubber or resin is provided. The elastic member 612 has upper and lower ends in a flange shape, and covers the inner peripheral surface, an upper end surface, and a lower end surface of the tubular portion 611.

The battery tray side restricting portion 62 has a convex portion 621 extending toward the down side from the tray support plate 38 in the up-down direction at a position where the tubular portion 611 of the electric motor side restricting portion 61 faces to the up side. The convex portion 621 has a cylindrical shape extending in the up-down direction.

The battery tray 3 is attached to the support frame plate 202 of the electric motor 20 in a state where the convex portion 621 of the battery tray side restricting portion 62 is inserted into the tubular portion 611 of the electric motor side restricting portion 61. The convex portion 621 of the battery tray side restricting portion 62 is inserted into the tubular portion 611 of the electric motor side restricting portion 61 by being spaced a predetermined distance apart from the elastic member 612 provided on the inner peripheral surface of the tubular portion 611 of the electric motor side restricting portion 61 in the front-rear direction and the left-right direction. Specifically, the convex portion 621 of the battery tray side restricting portion 62 and the elastic member 612 provided on the inner peripheral surface of the tubular portion 611 of the electric motor side restricting portion 61 are spaced from each other by a distance L61 in the front direction, a distance L62 in a rear direction, a distance L63 in a left direction, and a distance L64 in a right direction. In the present embodiment, the distances L61, L62, L63, L64 are equal to each other, and are, for example, 5 mm.

The electric motor side restricting portion 61 and the battery tray side restricting portion 62 are engaged with each other so as to be capable of relatively moving by the predetermined distance in the front-rear direction and the left-right direction. In the present embodiment, the convex portion 621 of the battery tray side restricting portion 62 can be relatively moved to the elastic member 612 provided on the inner peripheral surface of the tubular portion 611 of the electric motor side restricting portion 61 by the distance L61 in the front direction, the distance L62 in the rear direction, the distance L63 in the left direction, and the distance L64 in the right direction, which are separation distances between the convex portion 621 of the battery tray side restricting portion 62 and the elastic member 612 provided on the inner peripheral surface of the tubular portion 611 of the electric motor side restricting portion 61. When the convex portion 621 of the battery tray side restricting portion 62 relatively moves to the elastic member 612 provided on the inner peripheral surface of the tubular portion 611 of the electric motor side restricting portion 61 by the distance L61 in the front direction, the distance L62 in the rear direction, the distance L63 in the left direction, and the distance L64 in the right direction, the convex portion 621 comes into contact with the elastic member 612, and the relative movement is restricted so that the convex portion 621 does not move further to the elastic member 612.

Therefore, when vibration equal to or more than a predetermined value is generated in the electric power unit 1 with respect to the elastic force of the elastic members 50, the battery tray 3 and the battery 4 oscillate in the horizontal direction, and the convex portion 621 of the battery tray side restricting portion 62 comes into contact with the elastic member 612 provided on the inner peripheral surface of the tubular portion 611 of the electric motor side restricting portion 61. Therefore, when the vibration equal to or more than the predetermined value is generated in the electric power unit 1 with respect to the elastic force of the elastic members 50, the battery tray 3 and the battery 4 are restricted from oscillating at a large amplitude equal to or more than a predetermined value in the horizontal direction which is the oscillating direction. As a result, it is possible to prevent the battery tray 3 and the battery 4 from oscillating. Therefore, it is possible to prevent an occurrence of a failure due to the oscillation of the battery 4 at an amplitude equal to or more than the predetermined value, and it is possible to prevent an excessive stress from being applied to the elastic members 50.

At this time, since the convex portion 621 of the battery tray side restricting portion 62 is in contact with the elastic member 612, it is possible to reduce noise caused by a contact sound of the convex portion 621 of the battery tray side restricting portion 62 by elasticity of the elastic member 612, and it is possible to prevent an excessive stress from being applied to the convex portion 621 of the battery tray side restricting portion 62 and the tubular portion 611 of the electric motor side restricting portion 61.

In addition, the electric motor side restricting portion 61 and the battery tray side restricting portion 62 are engaged with each other so as to be capable of relatively moving by the predetermined distance in the front-rear direction and the left-right direction, and thus the elastic members 50 are elastically deformed in the oscillating direction with respect to oscillation at an amplitude less than the predetermined value, so that it is possible to prevent the battery tray 3 and the battery 4 from oscillating. On the other hand, the convex portion 621 of the battery tray side restricting portion 62 comes into contact with the elastic member 612 provided on the inner peripheral surface of the tubular portion 611 of the electric motor side restricting portion 61 with respect to the oscillation at the amplitude equal to or more than the predetermined value, so that it is possible to prevent the battery tray 3 and the battery 4 from oscillating. As a result, a load due to the oscillation of the battery tray 3 and the battery 4 can be distributed and borne by both the elastic members 50 and the oscillating direction restricting portion 60, and thus wear and deterioration of the elastic members 50 and the oscillating direction restricting portion 60 can be prevented.

When the convex portion 621 of the battery tray side restricting portion 62 relatively moves to the elastic member 612 provided on the inner peripheral surface of the tubular portion 611 of the electric motor side restricting portion 61 by the distance L61 in the front direction, the distance L62 in the rear direction, the distance L63 in the left direction, and the distance L64 in the right direction, the convex portion 621 comes into contact with the elastic member 612 to restrict the relative movement, and thus the battery tray 3 and the battery 4 can be restricted from oscillating at an amplitude equal to or more than the predetermined value in two directions of the front-rear direction and the left-right direction with respect to the electric motor 20. Therefore, it is possible to further prevent the occurrence of the failure due to the oscillation of the battery 4 at an amplitude equal to or more than the predetermined value, and it is possible to further prevent an excessive stress from being applied to the elastic members 50. In addition, since the distances L61, L62, L63, L64 are equal to each other, the battery tray 3 and the battery 4 can be equally restricted from oscillating at an amplitude equal to or more than the predetermined value in two directions of the front-rear direction and the left-right direction with respect to the electric motor 20. Therefore, it is possible to further efficiently prevent the occurrence of the failure due to the oscillation of the battery 4 at an amplitude equal to or more than the predetermined value, and it is possible to further efficiently prevent an excessive stress from being applied to the elastic members 50.

Further, the oscillating direction restricting portion 60 can restrict the oscillation of the battery tray 3 and the battery 4 with respect to the electric motor 20 at an amplitude equal to or more than the predetermined value by the tubular portion 611 of the electric motor side restricting portion 61 and the convex portion 621 of the battery tray side restricting portion 62. Therefore, with a simple configuration and a simple method, the battery tray 3 and the battery 4 can be restricted from oscillating with respect to the electric motor 20 at an amplitude equal to or more than the predetermined value.

The battery tray attachment surface 202a of the support frame plate 202 of the electric motor 20 is a concave-convex surface having a concave-convex shape in the up-down direction. In the present embodiment, the battery tray attachment surface 202a has a front side convex portion 202d protruding toward the up side in front of the electric motor side restricting portion 61 of the battery tray attachment surface 202a and extending in the left-right direction, and a rear side convex portion 202e protruding toward the up side behind the electric motor side restricting portion 61 of the battery tray attachment surface 202a and extending in the left-right direction.

When the battery tray 3 and the battery 4 relatively move to the electric motor 20 by a predetermined value or more in the up-down direction which is the attachment direction of the elastic members 50, the front side convex portion 202d and the rear side convex portion 202e of the battery tray attachment surface 202a come into contact with the tray support plate 38 of the battery tray 3. Therefore, the relative movement of the battery tray 3 and the battery 4 to the electric motor 20 in the up-down direction is restricted by the front side convex portion 202d and the rear side convex portion 202e of the battery tray attachment surface 202a. That is, the front side convex portion 202d and the rear side convex portion 202e of the battery tray attachment surface 202a restrict the battery tray 3 and the battery 4 from relatively moving to the electric motor 20 by the predetermined value or more in the up-down direction.

As a result, since the battery tray attachment surface 202a is formed as the concave-convex surface, rigidity of the battery tray attachment surface 202a is improved. In addition, since the front side convex portion 202d and the rear side convex portion 202e of the battery tray attachment surface 202a restrict the relative movement of the battery tray 3 and the battery 4 to the electric motor 20 in the up-down direction by the predetermined value or more, when a weight or vibration in the up-down direction is applied to the electric power unit 1, a load caused by the weight or the vibration can be distributed and borne by both the elastic members 50 and the front side convex portion 202d and the rear side convex portion 202e of the battery tray attachment surface 202a, thereby preventing the wear and deterioration of the elastic members 50.

In addition, the left end portion 38b and the right end portion 38c formed on the tray support plate 38 of the battery tray 3 are convex portions protruding toward the down side from the main surface 38a of the tray support plate 38 and extend in the front-rear direction, whereas the front side convex portion 202d and the rear side convex portion 202e protruding toward the up side from the battery tray attachment surface 202a extend in the left-right direction. Therefore, the front side convex portion 202d and the rear side convex portion 202e protruding toward the up side from the battery tray attachment surface 202a extend in a direction intersecting an extending direction of the left end portion 38b and the right end portion 38c formed on the tray support plate 38 of the battery tray 3.

Accordingly, when a weight or vibration in the up-down direction is applied to the electric power unit 1 and the front side convex portion 202d and the rear side convex portion 202e of the battery tray attachment surface 202a come into contact with the tray support plate 38 of the battery tray 3, even when an excessive stress is applied to the tray support plate 38 of the battery tray 3 and the battery tray attachment surface 202a, since the tray support plate 38 and the battery tray attachment surface 202a are the concave-convex surfaces and have high rigidity, the tray support plate 38 and the battery tray attachment surface 202a can be prevented from being deformed. Further, since the front side convex portion 202d and the rear side convex portion 202e of the battery tray attachment surface 202a extend in the direction intersecting the extending direction of the left end portion 38b and the right end portion 38c of the tray support plate 38, a stress applied to the tray support plate 38 of the battery tray 3 and the battery tray attachment surface 202a can be dispersed, and the tray support plate 38 and the battery tray attachment surface 202a can be further prevented from being deformed.

In the present embodiment, elastic members 202f made of an elastic body such as rubber or resin is provided on upper surfaces of the front side convex portion 202d and the rear side convex portion 202e of the battery tray attachment surface 202a. Therefore, when the battery tray 3 and the battery 4 relatively move to the electric motor 20 in the up-down direction by the predetermined value or more, the tray support plate 38 of the battery tray 3 comes into contact with the elastic members 202f provided on the front side convex portion 202d and the rear side convex portion 202e of the battery tray attachment surface 202a. In this manner, elasticity of the elastic member 202f can reduce noise caused by a contact sound of the tray support plate 38 of the battery tray 3.

The tray support plate 38 of the battery tray 3 and the elastic members 202f provided on the front side convex portion 202d and the rear side convex portion 202e of the battery tray attachment surface 202a have a distance L65 in the up-down direction. That is, the distance L65 is a relative movable distance between the battery tray attachment surface 202a and the battery tray 3 in the up-down direction.

In addition, in the leveling machine 100 on which the electric power unit 1 is mounted, the elastic members 50, the oscillating direction restricting portion 60, and the front side convex portion 202d and the rear side convex portion 202e can reduce transmission, to the battery tray 3, of not only the vibration generated due to driving of the electric motor 20 but also the vibration generated due to driving of the vibration mechanism portion 103 of the leveling machine 100 and vibration in the up-down direction when the rolling compaction plate 101a is excessively repelled.

### (PDU)

As illustrated in FIGS. 3, 4, and 8, the PDU 21 has a substantially rectangular parallelepiped shape which extends in the up-down direction, the left-right direction, and the front-rear direction and is long in the up-down direction. A rear surface of the PDU 21 serves as a heat sink, and a large number of fins protruding substantially horizontally toward the rear side are formed on the rear surface.

An upper side support portion 211 which supports the PDU 21, protrudes toward the rear side from the rear surface of the PDU 21 and extends substantially horizontally is provided at an upper end of the rear surface of the PDU 21. A lower side support portion 212 which supports the PDU 21, protrudes toward the rear side from the rear surface of the PDU 21 and extends substantially horizontally is provided at a lower end of the rear surface of the PDU 21.

### (Attachment of PDU)

Attachment of the PDU 21 to the PDU attachment surface 202b will be described with reference to FIGS. 4 and 8 to 11.

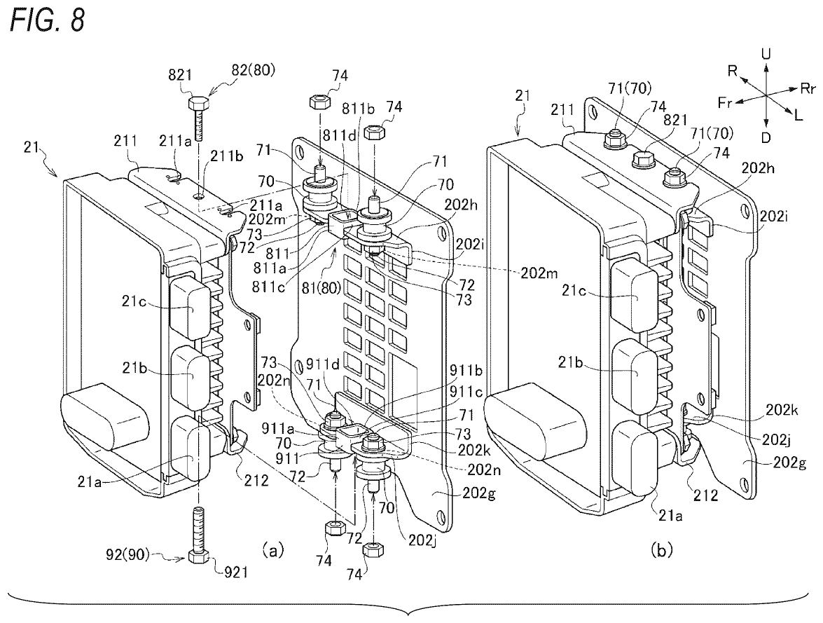

As illustrated in FIGS. 4 and 8, a flat plate-shaped PDU support plate 202g substantially perpendicular to the front-rear direction is fixed to a front surface of the PDU attachment surface 202b of the support frame plate 202 of the electric motor 20. An upper side attachment member 202i having an upper side attachment portion 202h protruding toward the front side from a front surface of the PDU support plate 202g and extending in the horizontal direction is fixed to an upper portion of the PDU support plate 202g. A lower side attachment member 202k having a lower side attachment portion 202j protruding toward the front side from the front surface of the PDU support plate 202g and extending in the horizontal direction is fixed to a lower portion of the PDU support plate 202g.

The upper side support portion 211 of the PDU 21 and the upper side attachment portion 202h of the PDU support plate 202g face each other in the up-down direction such that the upper side support portion 211 of the PDU 21 is on the up side and the upper side attachment portion 202h of the PDU support plate 202g is on the down side. The lower side support portion 212 of the PDU 21 and the lower side attachment portion 202j of the PDU support plate 202g face each other in the up-down direction such that the lower side support portion 212 of the PDU 21 is on the down side and the lower side attachment portion 202j of the PDU support plate 202g is on the up side.

Two pairs of elastic members 70 are disposed between the upper side support portion 211 of the PDU 21 and the upper side attachment portion 202h of the PDU support plate 202g and between the lower side support portion 212 of the PDU 21 and the lower side attachment portion 202j of the PDU support plate 202g, respectively, and each pair of elastic members 70 are disposed on a left end side and a right end side.

The upper side support portion 211 of the PDU 21 is attached to the upper side attachment portion 202h of the PDU support plate 202g via the elastic members 70. Similarly, the lower side support portion 212 of the PDU 21 is attached to the lower side attachment portion 202j of the PDU support plate 202g via the elastic members 70. In this manner, the PDU 21 is attached to the electric motor 20 via the elastic members 70. At this time, the elastic members 70 are respectively attached to the upper side support portion 211 and the upper side attachment portion 202h, and the lower side support portion 212 and the lower side attachment portion 202j in the up-down direction.

As described above, the PDU 21 is attached to the electric motor 20 via the elastic members 70 attached in the up-down direction. Therefore, the PDU 21 can oscillate with respect to the electric motor 20 in a substantially horizontal direction substantially perpendicular to the up-down direction, which is an attachment direction of the elastic members 70, by an elastic force of the elastic members 70. Further, the PDU 21 can be relatively moved to the electric motor 20 also in the up-down direction, which is the attachment direction of the elastic members 70, by the elastic force of the elastic members 70. As a result, the vibration generated by the vibration mechanism portion 103, the electric motor 20, and the like is absorbed by the elastic members 70, and thus it is possible to reduce transmission of the vibration generated by the vibration mechanism portion 103 and the electric motor 20 to the PDU 21.

Further, the upper side support portion 211 of the PDU 21 and the upper side attachment portion 202h of the PDU support plate 202g of the electric motor 20 are provided with an oscillating direction restricting portion 80 which restricts relative movement of the PDU 21 to the electric motor 20 in an oscillating direction substantially perpendicular to the attachment direction of the elastic members 70, that is, in a substantially horizontal direction substantially perpendicular to the up-down direction which is the attachment direction of the elastic members 70. Similarly, the lower side support portion 212 of the PDU 21 and the lower side attachment portion 202j of the PDU support plate 202g of the electric motor 20 are provided with an oscillating direction restricting portion 90 which restricts the relative movement of the PDU 21 to the electric motor 20 in the oscillating direction substantially perpendicular to the attachment direction of the elastic members 70, that is, in the substantially horizontal direction substantially perpendicular to the up-down direction which is the attachment direction of the elastic members 70.

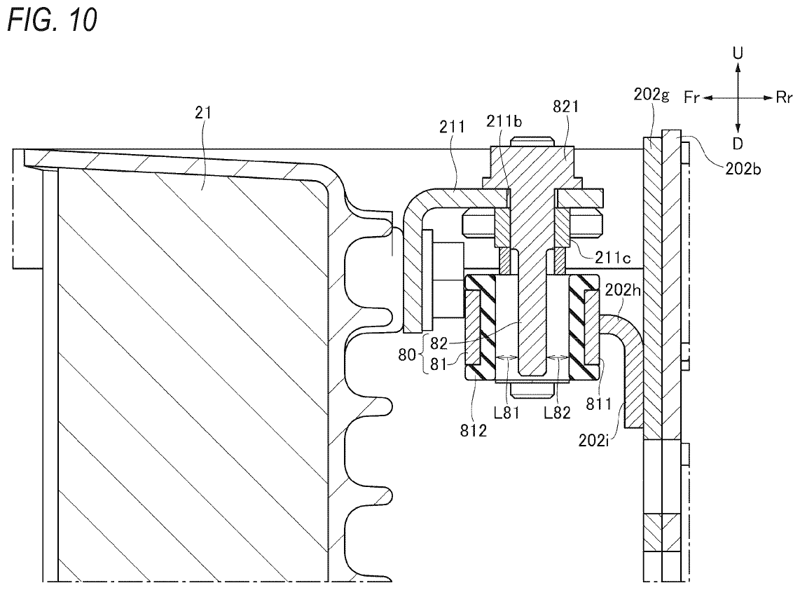

As illustrated in FIGS. 8 and 10, the oscillating direction restricting portion 80 includes an electric motor side restricting portion 81 provided on the upper side attachment portion 202h of the PDU support plate 202g of the electric motor 20, and a PDU side restricting portion 82 provided on the upper side support portion 211 of the PDU 21.

The electric motor side restricting portion 81 includes a tubular portion 811 which extends in the up-down direction and is formed at a substantially center portion of the upper side attachment portion 202h in the left-right direction. The tubular portion 811 has a rectangular tubular shape, and includes a front surface 811a and a rear surface 811b extending in the left-right direction, and a left side surface 811c and a right side surface 811d extending in the front-rear direction. On an inner peripheral surface of the tubular portion 811, for example, an elastic member 812 made of an elastic body such as rubber or resin is provided. The elastic member 812 has upper and lower ends in a flange shape, and covers the inner peripheral surface, an upper end surface, and a lower end surface of the tubular portion 811.

The PDU side restricting portion 82 includes an oscillation restricting bolt 821 which is inserted into the upper side support portion 211 at a position where the tubular portion 811 of the electric motor side restricting portion 81 faces to the up side. The oscillation restricting bolt 821 is attached to the upper side support portion 211 in the up-down direction from the up side toward the tubular portion 811 of the electric motor side restricting portion 81.

The PDU 21 is attached to the PDU support plate 202g of the electric motor 20 in a state where the oscillation restricting bolt 821 of the PDU side restricting portion 82 is inserted into the tubular portion 811 of the electric motor side restricting portion 81. The oscillation restricting bolt 821 of the PDU side restricting portion 82 is inserted into the tubular portion 811 of the electric motor side restricting portion 81 by being spaced a predetermined distance apart from the elastic member 812 provided on the inner peripheral surface of the tubular portion 811 of the electric motor side restricting portion 81 in the front-rear direction and the left-right direction. Specifically, the oscillation restricting bolt 821 of the PDU side restricting portion 82 and the elastic member 812 provided on the inner peripheral surface of the tubular portion 811 of the electric motor side restricting portion 81 are spaced from each other by a distance L81 in the front direction, a distance L82 in the rear direction, a distance L83 in the left direction, and a distance L84 in the right direction. In the present embodiment, the distances L81, L82, L83, L84 are equal to each other, and are, for example, 5 mm.

The electric motor side restricting portion 81 and the PDU side restricting portion 82 are engaged with each other so as to be capable of relatively moving by the predetermined distance in the front-rear direction and the left-right direction. In the present embodiment, the oscillation restricting bolt 821 of the PDU side restricting portion 82 can be relatively moved to the elastic member 812 provided on the inner peripheral surface of the tubular portion 811 of the electric motor side restricting portion 81 by the distance L81 in the front direction, the distance L82 in the rear direction, the distance L83 in the left direction, and the distance L84 in the right direction, which are separation distances between the oscillation restricting bolt 821 of the PDU side restricting portion 82 and the elastic member 812 provided on the inner peripheral surface of the tubular portion 811 of the electric motor side restricting portion 81. When the oscillation restricting bolt 821 of the PDU side restricting portion 82 relatively moves to the elastic member 812 provided on the inner peripheral surface of the tubular portion 811 of the electric motor side restricting portion 81 by the distance L81 in the front direction, the distance L82 in the rear direction, the distance L83 in the left direction, and the distance L84 in the right direction, the oscillation restricting bolt 821 comes into contact with the elastic member 812, and the relative movement is restricted so that the oscillation restricting bolt 821 does not move further to the elastic member 812. Therefore, the distances L81, L82, L83, L84 are relative movable distances between the battery tray attachment surface 202a and the battery tray 3 in the front direction, the rear direction, the left direction, and the right direction, respectively.

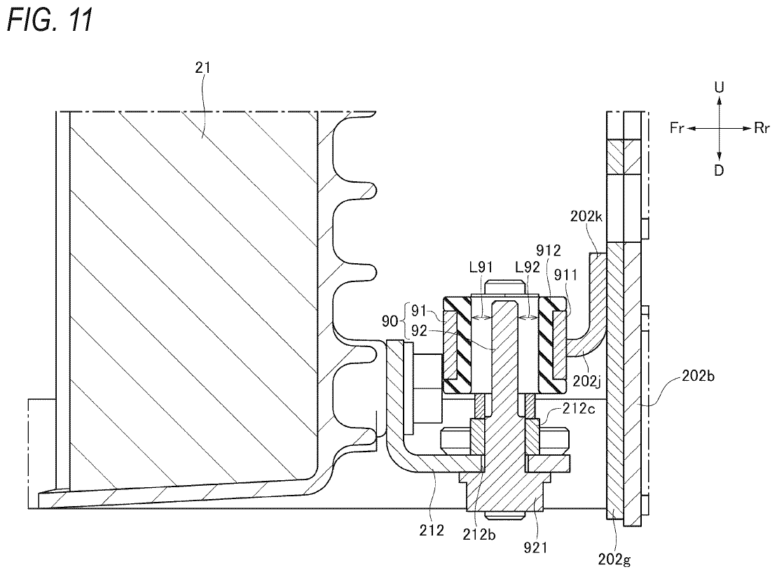

As illustrated in FIGS. 8 and 11, the oscillating direction restricting portion 90 includes an electric motor side restricting portion 91 provided on the lower side attachment portion 202j of the PDU support plate 202g of the electric motor 20, and a PDU side restricting portion 92 provided on the lower side support portion 212 of the PDU 21.

The electric motor side restricting portion 91 includes a tubular portion 911 which extends in the up-down direction and is formed at a substantially center portion of the lower side attachment portion 202j in the left-right direction. The tubular portion 911 has a rectangular tubular shape, and includes a front surface 911a and a rear surface 911b extending in the left-right direction, and a left side surface 911c and a right side surface 911d extending in the front-rear direction. On an inner peripheral surface of the tubular portion 911, for example, an elastic member 912 made of an elastic body such as rubber or resin is provided. The elastic member 912 has upper and lower ends in a flange shape, and covers the inner peripheral surface, an upper end surface, and a lower end surface of the tubular portion 811.

The PDU side restricting portion 92 includes an oscillation restricting bolt 921 which is inserted into the lower side support portion 212 at a position where the tubular portion 911 of the electric motor side restricting portion 91 faces to the down side. The oscillation restricting bolt 921 is attached to the lower side support portion 212 in the up-down direction from the down side toward the tubular portion 911 of the electric motor side restricting portion 91.

The PDU 21 is attached to the PDU support plate 202g of the electric motor 20 in a state where the oscillation restricting bolt 921 of the PDU side restricting portion 92 is inserted into the tubular portion 911 of the electric motor side restricting portion 91. The oscillation restricting bolt 921 of the PDU side restricting portion 92 is inserted into the tubular portion 911 of the electric motor side restricting portion 91 by being spaced a predetermined distance apart from the elastic member 912 provided on the inner peripheral surface of the tubular portion 911 of the electric motor side restricting portion 91 in the front-rear direction and the left-right direction. Specifically, the oscillation restricting bolt 921 of the PDU side restricting portion 92 and the elastic member 912 provided on the inner peripheral surface of the tubular portion 911 of the electric motor side restricting portion 91 are spaced from each other by a distance L91 in the front direction, a distance L92 in the rear direction, a distance L93 in the left direction, and a distance L94 in the right direction. In the present embodiment, the distances L91, L92, L93, L94 are equal to each other, and are, for example, 5 mm.

The electric motor side restricting portion 91 and the PDU side restricting portion 92 are engaged with each other so as to be capable of relatively moving by the predetermined distance in the front-rear direction and the left-right direction. In the present embodiment, the oscillation restricting bolt 921 of the PDU side restricting portion 92 can be relatively moved to the elastic member 912 provided on the inner peripheral surface of the tubular portion 911 of the electric motor side restricting portion 91 by the distance L91 in the front direction, the distance L92 in the rear direction, the distance L93 in the left direction, and the distance L94 in the right direction, which are separation distances between the oscillation restricting bolt 921 of the PDU side restricting portion 92 and the elastic member 912 provided on the inner peripheral surface of the tubular portion 911 of the electric motor side restricting portion 91. When the oscillation restricting bolt 921 of the PDU side restricting portion 92 relatively moves to the elastic member 912 provided on the inner peripheral surface of the tubular portion 911 of the electric motor side restricting portion 91 by the distance L91 in the front direction, the distance L92 in the rear direction, the distance L93 in the left direction, and the distance L94 in the right direction, the oscillation restricting bolt 921 comes into contact with the elastic member 912, and the relative movement is restricted so that the oscillation restricting bolt 921 does not move further to the elastic member 912.

Therefore, when the vibration equal to or more than the predetermined value is generated in the electric power unit 1 with respect to the elastic force of the elastic members 70, the PDU 21 oscillates in the horizontal direction, and the oscillation restricting bolts 821, 921 of the PDU side restricting portions 82, 92 come into contact with the elastic members 812, 912 provided on the inner peripheral surfaces of the tubular portion 811, 911 of the electric motor side restricting portions 81, 91. Therefore, when the vibration equal to or more than the predetermined value is generated in the electric power unit 1 with respect to the elastic force of the elastic members 70, the PDU 21 is restricted from oscillating at a large amplitude equal to or more than a predetermined value in the horizontal direction which is the oscillating direction. As a result, it is possible to prevent the PDU 21 from oscillating. Therefore, it is possible to prevent an occurrence of a failure due to the oscillation of the PDU 21 at an amplitude equal to or more than the predetermined value, and it is possible to prevent an excessive stress from being applied to the elastic members 70.

At this time, since the oscillation restricting bolts 821, 921 of the PDU side restricting portions 82, 92 are in contact with the elastic members 812, 912, it is possible to reduce noise caused by contact sounds of the oscillation restricting bolts 821, 921 of the PDU side restricting portions 82, 92 by elasticity of the elastic members 812, 912, and it is possible to prevent an excessive stress from being applied to the oscillation restricting bolts 821, 921 of the PDU side restricting portions 82, 92 and the tubular portions 811, 911 of the electric motor side restricting portions 81, 91.

In addition, the electric motor side restricting portions 81, 91 and the PDU side restricting portions 82, 92 are engaged with each other so as to be capable of relatively moving by the predetermined distance in the front-rear direction and the left-right direction, and thus the elastic members 70 are elastically deformed in the oscillating direction with respect to oscillation at an amplitude less than the predetermined value, so that it is possible to prevent the PDU 21 from oscillating. On the other hand, the oscillation restricting bolts 821, 921 of the PDU side restricting portions 82, 92 come into contact with the elastic members 812, 912 provided on the inner peripheral surfaces of the tubular portions 811, 911 of the electric motor side restricting portions 81, 91 with respect to the oscillation at the amplitude equal to or more than the predetermined value, so that it is possible to prevent the PDU 21 from oscillating. As a result, a load due to the oscillation of the PDU 21 can be distributed and borne by both the elastic members 70 and the oscillating direction restricting portions 80, 90, and thus wear and deterioration of the elastic members 70 and the oscillating direction restricting portions 80, 90 can be prevented.

When the oscillation restricting bolts 821, 921 of the PDU side restricting portions 82, 92 relatively move to the elastic members 812, 912 provided on the inner peripheral surfaces of the tubular portions 811, 911 of the electric motor side restricting portions 81, 91 by the distances L81, L91 in the front direction, the distances L82, L92 in the rear direction, the distances L83, L93 in the left direction, and the distances L84, L94 in the right direction, the oscillation restricting bolts 821, 921 come into contact with the elastic members 812, 912 to restrict the relative movement, and thus the PDU 21 can be restricted from oscillating at an amplitude equal to or more than the predetermined value in two directions of the front-rear direction and the left-right direction with respect to the electric motor 20. Therefore, it is possible to further prevent the occurrence of the failure due to the oscillation of the PDU 21 at an amplitude equal to or more than the predetermined value, and it is possible to further prevent an excessive stress from being applied to the elastic members 70. In addition, since the distances L81, L82, L83, L84 and the distances L91, L92, L93, L94 are equal to each other, the PDU 21 can be equally restricted from oscillating at an amplitude equal to or more than the predetermined value in two directions of the front-rear direction and the left-right direction with respect to the electric motor 20. Therefore, it is possible to further efficiently prevent the occurrence of the failure due to the oscillation of the PDU 21 at an amplitude equal to or more than the predetermined value, and it is possible to further efficiently prevent an excessive stress from being applied to the elastic members 70.

Further, the oscillating direction restricting portions 80, 90 can restrict the oscillation of the PDU 21 with respect to the electric motor 20 at an amplitude equal to or more than the predetermined value by the tubular portions 811, 911 of the electric motor side restricting portions 81, 91 and the oscillation restricting bolts 821, 921 of the PDU side restricting portion 82, 92. Therefore, with a simple configuration and a simple method, the PDU 21 can be restricted from oscillating with respect to the electric motor 20 at an amplitude equal to or more than the predetermined value.

### (Attachment Procedure of PDU)

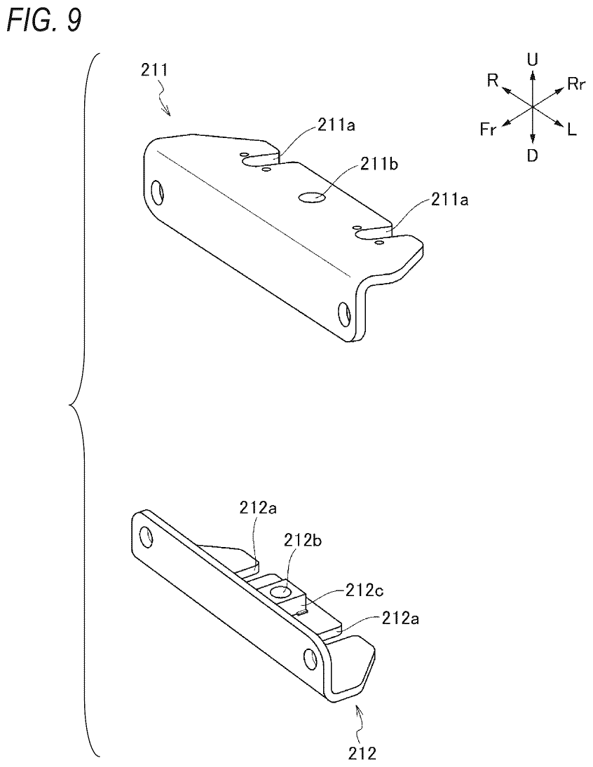

A procedure for attaching the PDU 21 to the PDU support plate 202g of the electric motor 20 will be described with reference to FIGS. 8 and 9.

As illustrated in (a) of FIG. 8 and FIG. 9, through holes 202m penetrating a left end portion and a right end portion of the upper side attachment portion 202h of the PDU support plate 202g in the up-down direction are provided at positions where the elastic members 70 are disposed. On a left end portion and a right end portion of the upper side support portion 211 of the PDU 21, notch portions 211a each having a concave shape toward the front side from a rear end are provided at the positions where the elastic members 70 are disposed. Between a pair of notch portions 211a provided at the left end portion and the right end portion of the upper side support portion 211 of the PDU 21, a through hole 211b, which penetrates the upper side support portion 211 in the up-down direction and into which the oscillation restricting bolt 821 of the PDU side restricting portion 82 is inserted, is provided at a substantially center portion of the upper side support portion 211 of the PDU 21 in the left-right direction. A nut 211c for fastening the oscillation restricting bolt 821 of the PDU side restricting portion 82 is fixed to a lower surface of the upper side support portion 211 of the PDU 21 at a position where the through hole 211b is provided (see FIG. 10).

Through holes 202n penetrating a left end portion and a right end portion of the lower side attachment portion 202j of the PDU support plate 202g in the up-down direction are provided at positions where the elastic members 70 are disposed. On a left end portion and a right end portion of the lower side support portion 212 of the PDU 21, notch portions 212a each having a concave shape toward the front side from a rear end are provided at the positions where the elastic members 70 are disposed. Between a pair of notch portions 212a provided at the left end portion and the right end portion of the lower side support portion 212 of the PDU 21, a through hole 212b, which penetrates the lower side support portion 212 in the up-down direction and into which the oscillation restricting bolt 921 of the PDU side restricting portion 92 is inserted, is provided at a substantially center portion of the lower side support portion 212 of the PDU 21 in the left-right direction. A nut 212c for fastening the oscillation restricting bolt 921 of the PDU side restricting portion 92 is fixed to an upper surface of the lower side support portion 212 of the PDU 21 at a position where the through hole 212b is provided (see FIG. 11).

The elastic member 70 has a substantially cylindrical shape extending in the up-down direction, and an upper end and a lower end thereof each has a large diameter so as to have a flange shape. The elastic member 70 is provided with an upper surface protruding portion 71 protruding toward the up side from an upper surface and a lower surface protruding portion 72 protruding toward the down side from a lower surface. Each of the upper surface protruding portion 71 and the lower surface protruding portion 72 has a cylindrical shape having a diameter smaller than that of the upper surface and the lower surface of the elastic member 70, and a screw groove is formed on an outer peripheral surface thereof.

First, as illustrated in (a) of FIG. 8, the elastic member 70 is disposed between the upper side support portion 211 of the PDU 21 and the upper side attachment portion 202h of the PDU support plate 202g such that the lower surface protruding portion 72 inserts through the through hole 202m of the upper side attachment portion 202h and protrudes the upper side attachment portion 202h toward the down side. Then, fastening nuts 73 are fastened to the lower surface protruding portions 72 protruding the upper side attachment portion 202h toward the down side. In this manner, the elastic member 70 is attached to the upper side attachment portion 202h.

Similarly, the elastic member 70 is disposed between the lower side support portion 212 of the PDU 21 and the lower side attachment portion 202j of the PDU support plate 202g such that the upper surface protruding portion 71 inserts through the through hole 202n of the lower side attachment portion 202j and protrudes the lower side attachment portion 202j toward the up side. Then, the fastening nuts 73 are fastened to the upper surface protruding portions 71 protruding the lower side attachment portion 202j toward the up side. In this manner, the elastic member 70 is attached to the lower side attachment portion 202j.

Next, as illustrated in (b) of FIG. 8, the elastic members 70 approach the PDU 21 from the front side in a state where the upper side attachment portion 202h and the lower side attachment portion 202j are attached. At this time, the upper surface protruding portions 71 of the elastic members 70 attached to the upper side attachment portion 202h are inserted into the notch portions 211a provided in the upper side support portion 211 of the PDU 21 from the rear ends of the notch portions 211a. Similarly, the lower surface protruding portions 72 of the elastic members 70 attached to the lower side attachment portion 202j are inserted into the notch portions 212a provided in the lower side support portion 212 of the PDU 21 from the rear ends of the notch portions 212a.

Then, in a state where the upper surface protruding portions 71 of the elastic members 70 attached to the upper side attachment portion 202h are inserted into the notch portions 211a provided in the upper side support portion 211 of the PDU 21 and the lower surface protruding portions 72 of the elastic members 70 attached to the lower side attachment portion 202j are inserted into the notch portions 212a provided in the lower side support portion 212 of the PDU 21, fastening nuts 74 are fastened to the upper surface protruding portions 71 of the elastic members 70 attached to the upper side attachment portion 202h, and the fastening nuts 74 are fastened to the lower surface protruding portions 72 of the elastic members 70 attached to the lower side attachment portion 202j. In this manner, the PDU 21 is attached to the electric motor 20 via the elastic members 70. At this time, the elastic members 70 are attached, in the up-down direction, to the upper side support portion 211 of the PDU 21 and the upper side attachment portion 202h of the PDU support plate 202g, or the lower side support portion 212 of the PDU 21 and the lower side attachment portion 202j of the PDU support plate 202g.

Next, the oscillation restricting bolt 821 of the PDU side restricting portion 82 is inserted into the through hole 211b from the up side of the upper side support portion 211 of the PDU 21, and is fastened to the nut 211c. As a result, the oscillation restricting bolt 821 is in a state of being inserted into the through hole 211b, extending in the up-down direction toward the tubular portion 811 formed in the upper side attachment portion 202h, and being inserted into the tubular portion 811. Similarly, the oscillation restricting bolt 921 of the PDU side restricting portion 92 is inserted into the through hole 212b from the down side of the lower side support portion 212 of the PDU 21, and is fastened to the nut 212c. As a result, the oscillation restricting bolt 921 is in a state of being inserted into the through hole 212b, extending in the up-down direction toward the tubular portion 911 formed in the lower side attachment portion 202j, and being inserted into the tubular portion 911.

Therefore, the PDU side restricting portion 82 has the oscillation restricting bolt 821, and the oscillation restricting bolt 821 can be attached to the upper side attachment portion 202h of the PDU support plate 202g after the PDU 21 is attached to the electric motor 20 via the elastic members 70. Similarly, the PDU side restricting portion 92 has the oscillation restricting bolt 921, and the oscillation restricting bolt 921 can be attached to the lower side attachment portion 202j of the PDU support plate 202g after the PDU 21 is attached to the electric motor 20 via the elastic members 70.

Accordingly, the oscillation restricting bolt 821 of the PDU side restricting portion 82 can be easily inserted into the tubular portion 811 of the electric motor side restricting portion 81. Similarly, the oscillation restricting bolt 921 of the PDU side restricting portion 92 can be easily inserted into the tubular portion 911 of the electric motor side restricting portion 91.

In addition, in the leveling machine 100 on which the electric power unit 1 is mounted, the elastic members 70 and the oscillating direction restricting portions 80, 90 can reduce transmission, to the PDU 21, of not only the vibration generated due to the driving of the electric motor 20 but also the vibration generated due to the driving of the vibration mechanism portion 103 of the leveling machine 100 and the vibration in the up-down direction when the rolling compaction plate 101a is excessively repelled.

### (Positional Relationship Between Battery Tray and First Electric Motor Cover)

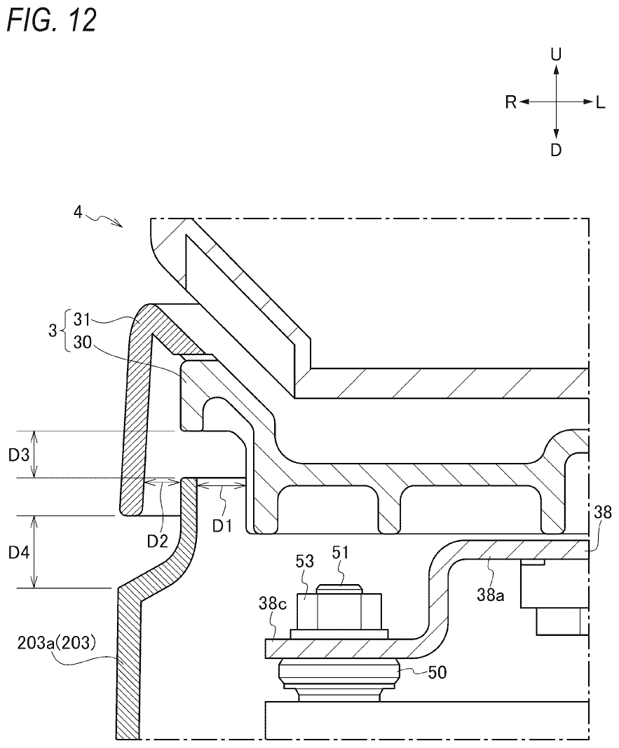

Next, a positional relationship between the battery tray 3 and the first electric motor cover 203a will be described with reference to FIG. 12.

As illustrated in FIG. 12, for waterproof and dustproof purposes, the tray main body 30 of the battery tray 3 is disposed inside the first electric motor cover 203a so that a part of the tray main body 30 overlaps with the first electric motor cover 203a in the up-down direction.

The decorative cover 31 of the battery tray 3 is disposed outside the first electric motor cover 203a so that a part of the decorative cover 31 overlaps with the first electric motor cover 203a in the up-down direction, in order to further prevent water, dust, and the like from entering the electric motor cover 203 (the first electric motor cover 203a, the second electric motor cover 203b, and the third electric motor cover 203c). In addition, in the left-right direction, the tray main body 30 of the battery tray 3 and the first electric motor cover 203a are disposed apart from each other by a distance D1. In the left-right direction, the decorative cover 31 of the battery tray 3 and the first electric motor cover 203a are disposed apart from each other by a distance D2.

At this time, the distance D1 between the tray main body 30 of the battery tray 3 and the first electric motor cover 203a is equal to or greater than the distance L64, which is a relative movable distance of the battery tray 3 in the right direction with respect to the electric motor 20. The distance D2 between the decorative cover 31 of the battery tray 3 and the first electric motor cover 203a is equal to or greater than the distance L63, which is a relative movable distance of the battery tray 3 in the left direction with respect to the electric motor 20.

Therefore, the tray main body 30 of the battery tray 3 and the first electric motor cover 203a, and the decorative cover 31 of the battery tray 3 and the first electric motor cover 203a are respectively disposed to be apart from each other in the left-right direction by the distances equal to or greater than the respective relative movable distances with respect to the electric motor 20.

Although detailed description is omitted, the tray main body 30 of the battery tray 3 and the first electric motor cover 203a, and the decorative cover 31 of the battery tray 3 and the first electric motor cover 203a are respectively disposed to be apart from each other also in the front-rear direction, similarly to the left-right direction, by distances equal to or greater than respective relative movable distances with respect to the electric motor 20.

Accordingly, even when the battery tray 3 relatively moves to the electric motor 20 in the front-rear direction and the left-right direction, the tray main body 30 and the decorative cover 31 of the battery tray 3 do not come into contact with the first electric motor cover 203a, and thus it is possible to prevent the tray main body 30 and the decorative cover 31 of the battery tray 3 and the first electric motor cover 203a from being damaged or broken.

In addition, in the up-down direction, the tray main body 30 of the battery tray 3 and the first electric motor cover 203a are disposed apart from each other by a distance D3. In the up-down direction, the decorative cover 31 of the battery tray 3 and the first electric motor cover 203a are disposed apart from each other by a distance D4.

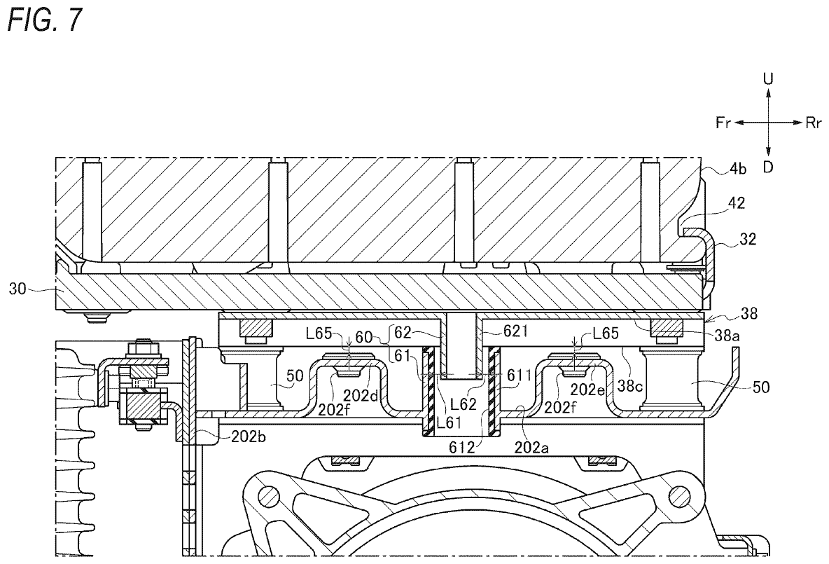

At this time, both the distance D3 between the tray main body 30 of the battery tray 3 and the first electric motor cover 203a and the distance D4 between the decorative cover 31 of the battery tray 3 and the first electric motor cover 203a are equal to or greater than the distance L65 (see FIGS. 6 and 7) which is the separation distance between the tray support plate 38 of the battery tray 3 and the elastic members 202f provided on the front side convex portion 202d and the rear side convex portion 202e of the battery tray attachment surface 202a.

Accordingly, even when the battery tray 3 relatively moves to the electric motor 20 in the up-down direction, the tray main body 30 and the decorative cover 31 of the battery tray 3 do not come into contact with the first electric motor cover 203a, and thus it is possible to prevent the tray main body 30 and the decorative cover 31 of the battery tray 3 and the first electric motor cover 203a from being damaged or broken.

Although the embodiment of the present invention has been described above, the present invention is not limited to the above-described embodiment, and modifications, improvements, and the like can be made as appropriate.

For example, although the electric power unit 1 is mounted on the leveling machine 100 in the present embodiment, the electric power unit 1 may be mounted on a construction machine or a working machine other than the leveling machine. In addition, the electric power unit 1 may be mounted on a machine, a device, or the like other than the construction machine and the working machine.

In addition, for example, in the present embodiment, the electric power unit 1 includes the electric motor 20, but the present invention is not limited to the electric motor, and the electric power unit 1 may include a rotary electric machine which generates electric power.

Further, for example, in the present embodiment, the electric motor side restricting portion 61 has the tubular portion 611, and the battery tray side restricting portion 62 has the convex portion 621, but the electric motor side restricting portion 61 may have a convex portion, and the battery tray side restricting portion 62 may have a tubular portion. Similarly, in the present embodiment, the electric motor side restricting portions 81, 91 have the tubular portions 811, 911, and the PDU side restricting portions 82, 92 have the oscillation restricting bolts 821, 921, but the electric motor side restricting portion 81, 91 may have oscillation restricting bolts, and the PDU side restricting portion 82, 92 may have tubular portions.

In addition, for example, in the present embodiment, the PDU side restricting portions 82, 92 have the oscillation restricting bolts 821, 921, but the present invention is not limited to the bolts, and any convex portion member extending in the up-down direction, such as an oscillation restricting pin, may be used.

The present specification describes at least the following matters. Although the corresponding components or the like in the above embodiment are shown in parentheses, the present invention is not limited thereto.

(1) An electric power unit (electric power unit 1) includes: a rotary electric machine (electric motor 20);
an electronic component (battery 4, PDU 21) for driving the rotary electric machine; and
an electronic component support member (battery tray 3, upper side attachment member 202i, and lower side attachment member 202k) which supports the electronic component, in which:
the electronic component support member is attached to the rotary electric machine via an elastic member (elastic members 50, 70); and
a restricting portion (oscillating direction restricting portions 60, 80, 90, front side convex portion 202d, and rear side convex portion 202e) which restricts relative movement of the electronic component support member and the rotary electric machine in at least one direction of an attachment direction (up-down direction) of the elastic member and an oscillating direction (horizontal direction) substantially perpendicular to the attachment direction is provided.

According to (1), even when vibration equal to or more than a predetermined value is generated in the electric power unit with respect to an elastic force of the elastic member, the relative movement of the electronic component support member and the rotary electric machine is restricted by the restricting portion, the electronic component support member and the electronic component can be restricted from oscillating at a large amplitude equal to or more than a predetermined value in at least one direction of the attachment direction and the oscillating direction. As a result, it is possible to prevent the electronic component support member and electronic component from oscillating. Therefore, it is possible to prevent an occurrence of a failure due to the oscillation of the electronic component at an amplitude equal to or more than the predetermined value, and it is possible to prevent an excessive stress from being applied to the elastic member.

(2) In the electric power unit according to (1),
the restricting portion is an oscillating direction restricting portion (oscillating direction restricting portions 60, 80, 90) which restricts the relative movement of the electronic component support member and the rotary electric machine in the oscillating direction,
the oscillating direction restricting portion includes:
   a rotary electric machine side restricting portion (electric motor side restricting portions 61, 81, 91) provided on the rotary electric machine; and
   an electronic component side restricting portion (battery tray side restricting portion 62, PDU side restricting portions 82, 92) provided on the electronic component support member; and
the rotary electric machine side restricting portion and the electronic component side restricting portion are engaged with each other to be relatively movable by a predetermined distance in the oscillating direction.

According to (2), the rotary electric machine side restricting portion and the electronic component side restricting portion are engaged with each other to be relatively movable by the predetermined distance in the oscillating direction, and thus the elastic member is elastically deformed in the oscillating direction with respect to oscillation at an amplitude less than the predetermined value, so that it is possible to prevent the electronic component support member and the electronic component from oscillating, and with respect to oscillation at an amplitude equal to or more than the predetermined value, the oscillating direction restricting portion can prevent the electronic component support member and the electronic component from oscillating. As a result, a load due to the oscillation of the electronic component support member and the electronic component can be distributed and borne by both the elastic member and the oscillating direction restricting portion, and thus wear and deterioration of the elastic member and the oscillating direction restricting portion can be prevented.

(3) In the electric power unit according to (2),
the rotary electric machine side restricting portion and the electronic component side restricting portion are engaged with each other to be relatively movable by the predetermined distance in a first oscillating direction (front-rear direction) perpendicular to the attachment direction and a second oscillating direction (left-right direction) perpendicular to both the attachment direction and the first oscillating direction; and
a relative movable distance in the first oscillating direction and a relative movable distance in the second oscillating direction are equal to each other.

According to (3), since the rotary electric machine side restricting portion and the electronic component side restricting portion are engaged with each other to be relatively movable by the predetermined distance in the two directions of the first oscillating direction and the second oscillating direction, it is possible to restrict the oscillation of the electronic component support member and the electronic component at an amplitude equal to or more than the predetermined value in the two directions of the first oscillating direction and the second oscillating direction. Therefore, it is possible to further prevent the occurrence of the failure due to the oscillation of the electronic component at an amplitude equal to or more than the predetermined value, and it is possible to further prevent an excessive stress from being applied to the elastic member.

In addition, since the relative movable distance of the first oscillating direction and the relative movable distance in the second oscillating direction are equal to each other, it is possible to equally restrict the oscillation of the electronic component support member and the electronic component at an amplitude equal to or more than the predetermined value in the two directions of the first oscillating direction and the second oscillating direction. Therefore, it is possible to further efficiently prevent the occurrence of the failure due to the oscillation of the electronic component at an amplitude equal to or more than the predetermined value, and it is possible to further efficiently prevent an excessive stress from being applied to the elastic member

(4) In the electric power unit according to (2) or (3),
one of the rotary electric machine side restricting portion and the electronic component side restricting portion is provided with a tubular portion (tubular portions 611, 811, 911) extending in the attachment direction, and the other is provided with a convex portion (convex portion 621, oscillation restricting bolts 821, 921) extending in the attachment direction toward the tubular portion, and
the electronic component support member is attached to the rotary electric machine in a state where the convex portion is inserted into the tubular portion.

According to (4), the oscillating direction restricting portion can restrict the oscillation of the electronic component support member and the electronic component at an amplitude equal to or more than the predetermined value by the tubular portion provided on one of the rotary electric machine side restricting portion and the electronic component side restricting portion and the convex portion provided on the other one. Therefore, with a simple configuration and a simple method, the electronic component support member and the electronic component can be restricted from oscillating at an amplitude equal to or more than the predetermined value.

(5) In the electric power unit according to (4),
the other of the rotary electric machine side restricting portion and the electronic component side restricting portion has:
   a through hole (through holes 211b, 212b) penetrating in the attachment direction; and
   a convex portion member (oscillation restricting bolts 821, 921) inserted into the through hole and extending in the attachment direction toward the tubular portion, and
the convex portion is formed by the convex portion member.

According to (5), since the convex portion is formed by the convex portion member inserted into the through hole, the convex portion can be formed by inserting the convex portion member into the through hole after the electronic component support member is attached to the rotary electric machine. Therefore, the convex portion can be easily inserted into the tubular portion.

(6) In the electric power unit according to any one of (2) to (5),
an outer periphery of the rotary electric machine is covered by a first exterior component (electric motor cover 203),
the electronic component support member includes a main body portion (tray main body 30) and a second exterior component (decorative cover 31) surrounding an outer periphery of the main body portion, and
at least one of the first exterior component and the second exterior component, and the first exterior component and the main body portion are disposed apart from each other by a distance, which is greater than a relative movable distance of the rotary electric machine and the electronic component support member, in the oscillating direction.

According to (6), at least one of the first exterior component and the second exterior component, and the first exterior component and the main body portion are disposed apart from each other by the relative movable distance of the rotary electric machine and the electronic component support member in the oscillating direction, and thus even when the electronic component support member and the electronic component relatively move to the rotary electric machine in the oscillating direction, the first exterior component and the second exterior component, and the first exterior component and the main body portion do not come into contact with each other. As a result, it is possible to prevent the first exterior component, the second exterior component and the main body portion from being damaged or broken.

(7) In the electric power unit according to (1),
the restricting portion is an attachment direction restricting portion (front side convex portion 202d, rear side convex portion 202e) which restricts the relative movement of the electronic component support member and the rotary electric machine in the oscillating direction, and
the attachment direction restricting portion is a convex portion provided on at least one of the electronic component support member and the rotary electric machine and protruding in the attachment direction.

According to (7), the attachment direction restricting portion can restrict the relative movement of the electronic component support member and the electronic component by a predetermined value or more in the attachment direction. As a result, when a weight or vibration in the attachment direction is applied to the electronic component, a load due to the weight or the vibration can be distributed and borne by both the elastic member and the attachment direction restricting portion, and thus wear and deterioration of the elastic member can be prevented.

(8) In the electric power unit according to (7),
the rotary electric machine has an electronic component support member attachment surface (battery tray attachment surface 202a) to which the electronic component support member is attached,
the electronic component support member is formed with a convex portion (left end portion 38b, right end portion 38c) which protrudes toward the electronic component support member attachment surface in the attachment direction and extends in a first direction (front-rear direction) perpendicular to the attachment direction, and
the attachment direction restricting portion is a convex portion formed on the electronic component support member attachment surface, protruding toward the electronic component support member in the attachment direction, intersecting the first direction, and extending in a second direction (left-right direction) perpendicular to the attachment direction.

According to (8), when a weight or vibration in the attachment direction is applied to the electric power unit and the attachment direction restricting portion formed on the electronic component support member attachment surface comes into contact with the convex portion formed on the electronic component support member, even when an excessive stress is applied to the electronic component support member and the electronic component support member attachment surface, since the electronic component support member and electronic component support member attachment surface have concave-convex surfaces, rigidity thereof is high, and the electronic component support member and electronic component support member attachment surface can be prevented from being deformed. Further, since the attachment direction restricting portion formed on the electronic component support member attachment surface extends in the second direction intersecting with the first direction which is an extending direction of the convex portion formed on the electronic component support member, a stress applied to the electronic component support member and the electronic component support member attachment surface can be dispersed, and the electronic component support member and electronic component support member attachment surface can be further prevented from being deformed.

(9) In the electric power unit according to (7) or (8),
an outer periphery of the rotary electric machine is covered by a first exterior component (electric motor cover 203),
the electronic component support member includes a main body portion (tray main body 30) and a second exterior component (decorative cover 31) surrounding an outer periphery of the main body portion, and
at least one of the first exterior component and the second exterior component, and the first exterior component and the main body portion are disposed apart from each other by a distance, which is greater than a relative movable distance of the rotary electric machine and the electronic component support member, in the attachment direction.

According to (9), at least one of the first exterior component and the second exterior component, and the first exterior component and the main body portion are disposed apart from each other by the relative movable distance of the rotary electric machine and the electronic component support member in the attachment direction, and thus even when the electronic component support member and the electronic component relatively move to the rotary electric machine in the attachment direction, the first exterior component and the second exterior component, and the first exterior component and the main body portion do not come into contact with each other. As a result, it is possible to prevent the first exterior component, the second exterior component and the main body portion from being damaged or broken.

(10) A working machine (leveling machine 100) including the electric power unit according to any one of (1) to (9).

According to (10), the elastic member and the oscillating direction restricting portion can reduce transmission, to the electronic component support member and the electronic component, of not only vibration generated due to driving of the rotary electric machine of the electric power unit but also vibration generated due to driving of the working machine.

### REFERENCE SIGNS LIST

1 electric power unit
3 battery tray (electronic component support member)
30 tray main body (main body portion)
31 decorative cover (second exterior component)
38b left end portion (convex portion)
38c right end portion (convex portion)
4 battery (electronic component)
20 electric motor (rotary electric machine)
202a battery tray attachment surface (electronic component support member)
202d front side convex portion (restricting portion, attachment direction restricting portion)
202e rear side convex portion (restricting portion, attachment direction restricting portion)
202i upper side attachment member (electronic component support member)
202k lower side attachment member (electronic component support member)
203 electric motor cover (first exterior component)
21 PDU (electronic component)
211b through hole
212b through hole
50 elastic member
60 oscillating direction restricting portion (restricting portion)
61 electric motor side restricting portion (rotary electric machine side restricting portion)
611 tubular portion
62 battery tray side restricting portion (electronic component side restricting portion)
621 convex portion
70 elastic member
80 oscillating direction restricting portion (restricting portion)
81 electric motor side restricting portion (rotary electric machine side restricting portion)
811 tubular portion
82 PDU side restricting portion (electronic component side restricting portion)
821 oscillation restricting bolt (convex portion, convex portion member)
90 oscillating direction restricting portion (restricting portion)
91 electric motor side restricting portion (rotary electric machine side restricting portion)
911 tubular portion
92 PDU side restricting portion (electronic component side restricting portion)
921 oscillation restricting bolt (convex portion, convex portion member)
100 leveling machine (working machine)

1. An electric power unit comprising:
a rotary electric machine;
an electronic component configured to drive the rotary electric machine; and
an electronic component support member which supports the electronic component, wherein:
the electronic component support member is attached to the rotary electric machine via an elastic member;
the electronic component is disposed in a direction perpendicular to a rotation axis of the rotary electric machine; and
a restricting portion which restricts relative movement of the electronic component support member and the rotary electric machine in an oscillating direction substantially perpendicular to an attachment direction of the elastic member is provided.

2. The electric power unit according to claim 1, wherein:
the electronic component includes a battery serving as an energy source for driving the electric power unit, and a PDU that controls distribution of electric power from the battery to the rotary electric machine;
the electric power unit further comprises a battery tray attachment surface extending over an upper surface of the rotary electric machine, and a PDU attachment surface extending over a front surface of the rotary electric machine; and
the battery is fixed to the battery tray attachment surface via an elastic member, the PDU is fixed to the PDU attachment surface via an elastic member.

3. The electric power unit according to claim 2, wherein:
a base plate is provided below the rotary electric machine; and
an attachment direction of the elastic member provided between the battery and the battery tray attachment surface and the elastic member provided between the PDU and the PDU attachment surface is an up-down direction.

4. The electric power unit according to claim 2, wherein:
the elastic member provided between the PDU and the PDU attachment surface overlaps with the PDU in a front-rear direction.

5. The electric power unit according to claim 2, wherein:
the electronic component support member includes a main body portion that supports the battery and covers upper portions of the rotary electric machine and the PDU;
the restricting portion is an attachment direction restricting portion which restricts the relative movement of the electronic component support member and the rotary electric machine in the attachment direction; and
the attachment direction restricting portion is a convex portion provided on at least one of the electronic component support member and the rotary electric machine, and protruding in the attachment direction.

6. The electric power unit according to claim 1, wherein:
the elastic member has a cylindrical shape extending in an up-down direction, and includes an upper surface protruding portion protruding toward an up side from an upper surface and a lower surface protruding portion protruding toward a down side from a lower surface;
the upper surface protruding portion is fixed to the electronic component support member; and
the lower surface protruding portion is fixed to the rotary electric machine.

7. The electric power unit according to claim 1, wherein:
the restricting portion is an oscillating direction restricting portion which restricts the relative movement of the electronic component support member and the rotary electric machine in the oscillating direction;
the oscillating direction restricting portion includes:
a rotary electric machine side restricting portion provided on the rotary electric machine; and
an electronic component side restricting portion provided on the electronic component support member;
the rotary electric machine side restricting portion and the electronic component side restricting portion are engaged with each other to be relatively movable by a predetermined distance in the oscillating direction;
one of the rotary electric machine side restricting portion and the electronic component side restricting portion is provided with a tubular portion extending in the attachment direction, and the other is provided with a convex portion extending in the attachment direction toward the tubular portion;
the electronic component support member is attached to the rotary electric machine in a state where the convex portion is inserted into the tubular portion;
the other of the rotary electric machine side restricting portion and the electronic component side restricting portion has:
a through hole penetrating in the attachment direction; and
a convex portion member inserted into the through hole and extending in the attachment direction toward the tubular portion; and
the convex portion is formed by the convex portion member.

8. The electric power unit according to claim 1, wherein:
an outer periphery of the rotary electric machine is covered by a first exterior component;
the electronic component support member includes a main body portion and a second exterior component surrounding an outer periphery of the main body portion; and
at least one of the first exterior component and the second exterior component, and the first exterior component and the main body portion are disposed apart from each other by a distance, which is equal to or greater than a relative movable distance of the rotary electric machine and the electronic component support member, in the oscillating direction.

9. The electric power unit according to claim 5, wherein:
the rotary electric machine has an electronic component support member attachment surface to which the electronic component support member is attached;
the electronic component support member is formed with a convex portion which protrudes toward the electronic component support member attachment surface in the attachment direction and extends in a first direction perpendicular to the attachment direction; and
the attachment direction restricting portion is a convex portion formed on the electronic component support member attachment surface, protruding toward the electronic component support member in the attachment direction, and extending in a second direction intersecting the first direction and perpendicular to the attachment direction.

10. The electric power unit according to claim 5, wherein:
an outer periphery of the rotary electric machine is covered by a first exterior component;
the electronic component support member includes a main body portion and a second exterior component surrounding an outer periphery of the main body portion; and
at least one of the first exterior component and the second exterior component, and the first exterior component and the main body portion are disposed apart from each other by a distance, which is equal to or greater than a relative movable distance of the rotary electric machine and the electronic component support member, in the attachment direction.
